(19) United States
(12) Patent Application Publication
(10) Pub. No.: US 2026/0280459 A1
(43) Pub. Date: Sep. 17, 2026

(54) CALCULATION METHODS FOR MOTOR ELECTROMAGNETIC TORQUE AND MAXIMUM TORQUE PER AMPERE, AND MOTOR CONTROL METHOD BASED ON VECTOR MAGNETIC CIRCUIT

(71) Applicants: SOUTHEAST UNIVERSITY, Nanjing (CN); NORTH CHINA ELECTRIC POWER UNIVERSITY(BAODING), Baoding (CN)

(72) Inventors: Ming CHENG, Nanjing (CN); Xinkai ZHU, Baoding (CN); Wei QIN, Nanjing (CN); Dajun ZHAO, Baoding (CN); Changhao SONG, Baoding (CN); Yabin LIU, Baoding (CN); Minmin LI, Baoding (CN)

(21) Appl. No.: 19/670,212

(22) Filed: May 7, 2026

Related U.S. Application Data
(63) Continuation of application No. PCT/CN2025/077167, filed on Feb. 13, 2025.

(30) Foreign Application Priority Data
Jan. 13, 2025 (CN) 202510046779.9

(51) Int. Cl. H02P 21/20; H02P 21/22

(52) U.S. Cl. CPC H02P 21/20; H02P 21/22; H02P 2207/055

(57) ABSTRACT

According to calculation methods for motor electromagnetic torque and maximum torque per ampere (MTPA), and a motor control method based on a vector magnetic circuit, vector magnetic circuit models for a permanent magnet motor are established. In the model, an equivalent inductance is used for characterizing an influence of eddy current and hysteresis effects in magnetic materials on the motor electromagnetic torque. Through a coordinate transformation, an electromagnetic torque equation of the vector magnetic circuit for the permanent magnet motor that incorporates the equivalent inductance is established, providing an MTPA control method for the permanent magnet motor. The methods provided in the present disclosure fully consider the influence of eddy current and hysteresis effects in magnetic materials on the motor electromagnetic torque. By using the provided MTPA control method, more accurate torque control of the permanent magnet motor is achieved.

### CROSS-REFERENCE TO RELATED APPLICATIONS

This application is a continuation of PCT/CN2025/077167, filed on Feb. 13, 2025 and claims priority of Chinese Patent Application No. 202510046779.9, filed on Jan. 13, 2025, the entire contents of which are incorporated herein by reference.

### TECHNICAL FIELD

The present disclosure belongs to the technical field of motor control, and specifically relates to calculation methods for motor electromagnetic torque and maximum torque per ampere (MTPA), and a motor control method based on a vector magnetic circuit.

### BACKGROUND

Surface permanent magnet synchronous motors (SPMSMs) offer the advantages of a simple structure, high power density, wide speed regulation range, and high working efficiency. Furthermore, these motors are widely used in industries such as industrial manufacturing, electric vehicles, and home appliances. SPMSM performance is not only affected by the motor structure but is also critically influenced by control algorithms, among which vector control is one of the most common control methods for SPMSMs. Vector control for alternating current (AC) motors references the mutual perpendicularity between the excitation current and the armature current in direct current (DC) motors, where no coupling exists between the two. Based on the Clark transformation and Park transformation in coordinate transformation theory, vector control decomposes the three-phase stator currents into independent torque components, i.e., quadrature-axis (q-axis) current, and excitation components, i.e., direct-axis (d-axis) current, achieving decoupled control of the magnetic field and torque of the AC motor, thereby causing the AC motor to exhibit control performance similar to that of a DC motor.

Professor Ming Cheng's research team at Southeast University has discovered the phenomena of magductance and hysteretance in magnetic circuits, establishing a vector magnetic circuit theory incorporating the three elements of reluctance, magductance, and hysteretance, as well as the magneto-electric power law. This discovery provides a novel approach for accounting for iron losses in motors, different from the conventional method that uses equivalent resistance. In this theory, the active power loss caused by the magductance element corresponds to the eddy current loss in the magnetic circuit, while the active power loss caused by the hysteretance element corresponds to the hysteresis loss in the magnetic circuit. By introducing magductance and hysteretance into a permanent magnet motor model, the eddy current and hysteresis effects on the permanent magnet flux and the stator flux excited by the armature current can be taken into account.

### SUMMARY

An objective of the present disclosure is to provide a calculation method for motor electromagnetic torque based on a vector magnetic circuit to achieve more accurate modeling of a permanent magnet motor and more precise calculation of the electromagnetic torque, where a magnetic impedance angle is used for characterizing a phase difference between a magnetomotive force and a magnetic flux caused by iron loss. The method fully considers the influence of eddy current and hysteresis effects in magnetic materials on the motor electromagnetic torque.

The present disclosure provides a calculation method for surface permanent magnet synchronous motor (SPMSM) electromagnetic torque based on a vector magnetic circuit. An SPMSM electromagnetic torque equation, which is based on the vector magnetic circuit and considers eddy current and hysteresis effects in a direct-quadrature (d-q) coordinate system, is expressed as:

$${T}_{δ} = \frac{3}{2} {p}_{n} [ \frac{1}{2} {L}_{s} sin 2 δ * ( {i}_{d}^{2} + {i}_{q}^{2} ) + {ψ}_{f} {cos}^{2} δ * {i}_{q} + \frac{1}{2} {ψ}_{f} sin 2 δ * {i}_{d} ] \qquad ( 1 )$$

where i_{d} and i_{d} are a direct-axis (d-axis) current and a quadrature-axis (q-axis) current in the d-q coordinate system, Lₛ is inductance in the d-q coordinate system, ψ_{f} is a permanent magnet flux linkage, pₙ is the number of pole pairs of the motor, δ is the magnetic impedance angle, and T_{δ} is the SPMSM electromagnetic torque, which is based on the vector magnetic circuit and considers the eddy current and hysteresis effects in the d-q coordinate system.

Based on the SPMSM electromagnetic torque equation of the present disclosure, the present disclosure further provides a calculation method for SPMSM maximum torque per ampere (MTPA) based on a vector magnetic circuit. The SPMSM electromagnetic torque equation includes a d-axis current component i_{d} and a q-axis current component i_{q}, so it is necessary to find an optimal combination of a d-axis current and a q-axis current under a current operating state to obtain the MTPA, expressed as follows:

$$\{ \begin{matrix}{T}_{δ} = \frac{3}{2} {p}_{n} [ \frac{1}{2} {L}_{s} sin 2 δ * ( {i}_{d}^{2} + {i}_{q}^{2} ) + {ψ}_{f} {cos}^{2} δ * {i}_{q} + \frac{1}{2} {ψ}_{f} sin 2 δ * {i}_{d} ] \\ {i}_{s} = min \sqrt{{i}_{d}^{2} + {i}_{q}^{2}}\end{matrix} \qquad ( 2 )$$

and a relationship between a stator current vector and the d-axis current and the q-axis current is expressed as:

$$\{ \begin{matrix}{i}_{d} = {i}_{s} cos β \\ {i}_{q} = {i}_{s} sin β\end{matrix} \qquad ( 3 )$$

where i_{d} and i_{q} are the d-axis current and the q-axis current in the d-q coordinate system, iₛ is a stator current vector in the d-q coordinate system, β is a stator current vector angle, which is an angle between the stator current vector iₛ and the d-axis, ψ_{f} is the permanent magnet flux linkage, pₙ is the number of pole pairs of the motor, and δ is the magnetic impedance angle.

Further, Equation (3) is substituted into the electromagnetic torque equation in Equation (2), obtaining a relationship between the electromagnetic torque T_{δ} and the stator current vector angle β, as follows:

$${T}_{δ} = \frac{3}{2} {p}_{n} [ \frac{1}{2} {L}_{s} {i}_{s}^{2} sin 2 δ + {ψ}_{f} {cos}^{2} δ ( {i}_{s} sin β ) + \frac{1}{2} {ψ}_{f} sin 2 δ ( {i}_{s} cos β ) ] \qquad ( 4 )$$

a phase-shift process is performed on the stator current vector iₛ, further obtaining an expression of an electromagnetic torque per unit current F(β), as follows:

$$F ( β ) = \frac{{T}_{δ}}{{i}_{s}} = \frac{3}{4} {p}_{n} {L}_{s} {i}_{s} sin 2 δ + \frac{3}{2} {p}_{n} {ψ}_{f} sin β {cos}^{2} δ + \frac{3}{4} {p}_{n} {ψ}_{f} sin 2 δcos β \qquad ( 5 )$$

when a derivative of an electromagnetic torque per unit current with respect to a stator current vector angle is equal to zero, the electromagnetic torque per unit current achieves a maximum value, indicating that a motor operating point corresponding to the stator current vector angle is an MTPA control point, specifically expressed as a relationship to be satisfied for maximizing the electromagnetic torque per unit current F(β):

$$\frac{\partial F ( β )}{\partial β} = \frac{3}{2} {p}_{n} {ψ}_{f} cos β {cos}^{2} δ - \frac{3}{4} {p}_{n} {ψ}_{f} sin 2 δsin β = 0 \qquad ( 6 )$$

further obtaining:

$$β = arctan ( \frac{1}{tan δ} ) . \qquad ( 7 )$$

Further, two vector magnetic circuit parameters, namely magductance [symbol] and hysteretance C, are introduced into d-axis and q-axis vector magnetic circuit models of the SPMSM, in which the magductance [symbol] and the hysteretance C are capable of causing a magnetic flux to lag behind a magnetomotive force or a current, and an angle by which the magnetic flux lags behind the magnetomotive force or the current is a magnetic impedance angle δ, expressed as:

$$δ = arctan ( \frac{{ωℒ}_{eq}}{{ℛ}_{s}} ) = arctan ( \frac{ωℒ + \frac{1}{ω C}}{{ℛ}_{s}} ) \qquad ( 8 )$$

an expression is defined as:

$$k = \frac{{ℒ}_{eq}}{{N}^{2}} = \frac{ℒ + \frac{1}{{ω}^{2} C}}{{N}^{2}} \qquad ( 9 )$$

where k is referred to as an equivalent magductance parameter; and
since reluctance is expressed as

$${ℛ}_{s} = \frac{{N}^{2}}{{L}_{s}} ,$$

the magnetic impedance angle S of the SPMSM is expressed as:

$$δ = arctan ( ω {L}_{s} k ) \qquad ( 3 )$$

where [symbol] is magductance in the d-q coordinate system, C is hysteretance in the d-q coordinate system, [symbol] _{eq} is equivalent magductance in the d-q coordinate system, [symbol] ₛ is reluctance in the d-q coordinate system, Lₛ is inductance in the d-q coordinate system, k is an equivalent magductance coefficient, δ is the magnetic impedance angle, ω is electrical angular velocity of a rotor, and N is the number of turns of armature winding.

Further, a voltage equation of the SPMSM based on the vector magnetic circuit is expressed as:

$$[ \begin{matrix}{u}_{ℛ} \\ {u}_{ℒ}\end{matrix} ] = [ \begin{matrix}{R}_{s} cos δ + {pL}_{s} cos δ & - ω {L}_{s} cos δ \\ ω {L}_{s} cos δ & {R}_{s} cos δ + {pL}_{s} cos δ\end{matrix} ] [ \begin{matrix}{i}_{d} \\ {i}_{q}\end{matrix} ] + [ \begin{matrix}0 \\ ω {ψ}_{f} cos δ\end{matrix} ] \qquad ( 9 )$$

where [symbol] and [symbol] are voltages in an R-L coordinate system, i_{d} and i_{q} are the currents in the d-q coordinate system, Lₛ is inductance in the d-q coordinate system, Rₛ is resistance in the d-q coordinate system, ψ_{f} is the permanent magnet flux linkage, δ is the magnetic impedance angle, ω is electrical angular velocity of a rotor, and p is a differential operator.

A relationship between the voltages in the R-L coordinate system and voltages in the d-q coordinate system is expressed as:

$$[ \begin{matrix}{u}_{ℛ} \\ {u}_{ℒ}\end{matrix} ] = {M}_{δ} [ \begin{matrix}{u}_{d} \\ {u}_{q}\end{matrix} ] \qquad ( 10 )$$

where Mₛ is a coordinate transformation matrix, expressed as:

$${M}_{δ} = [ \begin{matrix}cos δ & - sin δ \\ sin δ & cos δ\end{matrix} ] . \qquad ( 11 )$$

The present disclosure further provides an SPMSM control method based on a vector magnetic circuit, including the steps of:
sampling three-phase currents of the SPMSM to obtain sampled values

$${i}_{a}^{*} , {i}_{b}^{*} , and {i}_{c}^{*} ,$$

and performing a coordinate transformation on

$${i}_{a}^{*} , {i}_{b}^{*} , and {i}_{c}^{*}$$

to obtain current sampled values

$${i}_{d}^{*} and {i}_{q}^{*}$$

in a d-q coordinate system;
processing an error between a rotor electrical angular velocity ω* and a rotor electrical angular velocity set value ω by a proportional-integral (PI) controller to obtain a stator current vector iₛ, and obtaining a d-axis current set value i_{d} and a q-axis current set value i_{q} through a relationship between the stator current vector and q-axis and d-axis currents, specifically:

$${i}_{q} = {i}_{s} sin β ,$$

$${i}_{d} = {i}_{s} cos β , and$$

$$β = arc tan ( \frac{1}{tan δ} ) ,$$

where β represents a stator current vector angle, and S represents the magnetic impedance angle; and
inputting errors between the current sampled values

$${i}_{d}^{*} and {i}_{q}^{*}$$

in the d-q coordinate system and the set values i_{d} and i_{q} into two PI controllers to obtain voltage set values [symbol] and [symbol] in an R-L coordinate system; performing an inverse transformation on [symbol] and [symbol] using the coordinate transformation matrix M_{δ} to obtain voltage set values u_{d} and u_{q} in the d-q coordinate system; performing an inverse Park transformation to transform the voltage set values u_{d} and u_{q} in the d-q coordinate system into voltage set values u_{α} and u_{β} in an a-b coordinate system; synthesizing a voltage space vector using u_{α} and u_{β}; inputting the voltage space vector into a voltage space vector pulse width modulation (SVPWM) module for modulation; and outputting state encoding values of three half-bridges to control metal-oxide-semiconductor (MOS) transistor switches of a three-phase inverter for controlling the motor.

Further, in the present disclosure, an operating point of the motor corresponding to the stator current vector angle β is an MTPA control point.

The electromagnetic torque equation and control method according to the present disclosure, when compared with conventional electromagnetic torque equations and control methods, have the following beneficial effects.

According to the electromagnetic torque equation based on the vector magnetic circuit, the present disclosure provides an MTPA control method. By using the control method, the torque output of a permanent magnet motor is maximized, thereby improving torque utilization compared to an i_{d}=0 control method, while achieving more precise torque control of the permanent magnet motor.

The present disclosure provides an SPMSM electromagnetic torque equation based on the vector magnetic circuit. This equation resolves the inconsistency between calculated and measured electromagnetic torque values under real operating conditions, which is of great significance for motor design and practical numerical calculations in practical engineering applications.

### BRIEF DESCRIPTION OF THE DRAWINGS

To facilitate a clearer and more intuitive understanding of the relevant principles and content of the present disclosure, the accompanying drawings are provided for easier comprehension.

FIG. 1 is a schematic diagram showing a relationship between an R-L coordinate system and a direct-quadrature (d-q) coordinate system established in the present disclosure.

FIG. 2 is a schematic diagram showing a relationship among a direct-axis (d-axis) current i_{d}, a quadrature-axis (q-axis) current i_{q}, and a stator current vector iₛ in the maximum torque per ampere (MTPA) control.

FIG. 3 is a block diagram of an MTPA control method for a surface permanent magnet synchronous motor (SPMSM) based on a vector magnetic circuit according to the present disclosure.

FIG. 4A is a simulation effect diagram showing a d-axis current obtained using the control method of the present disclosure when a motor speed is 1,500 r/min;

FIG. 4B is a simulation effect diagram showing a d-axis current obtained using a conventional vector control method when the motor speed is 1,500 r/min; and

FIG. 4C is a simulation effect diagram showing a d-axis current difference obtained using the control method of the present disclosure and the conventional vector control method when the motor speed is 1,500 r/min.

FIG. 5A is a simulation effect diagram showing a q-axis current obtained using the control method of the present disclosure when a motor speed is 1,500 r/min;

FIG. 5B is a simulation effect diagram showing a q-axis current obtained using a conventional vector control method when the motor speed is 1,500 r/min; and

FIG. 5C is a simulation effect diagram showing a q-axis current difference obtained using the control method of the present disclosure and the conventional vector control method when the motor speed is 1,500 r/min.

FIG. 6A is a simulation effect diagram showing a torque-to-current ratio obtained using the control method of the present disclosure when a motor speed is 1,500 r/min;

FIG. 6B is a simulation effect diagram showing a torque-to-current ratio obtained using a conventional vector control method when the motor speed is 1,500 r/min; and

FIG. 6C is a simulation effect diagram showing a torque-to-current ratio difference obtained using the control method of the present disclosure and the conventional vector control method when the motor speed is 1,500 r/min.

FIG. 7A is a simulation effect diagram showing a d-axis current obtained using the control method of the present disclosure when a motor speed is 2,500 r/min;

FIG. 7B is a simulation effect diagram showing a d-axis current obtained using a conventional vector control method when the motor speed is 2,500 r/min; and

FIG. 7C is a simulation effect diagram showing a d-axis current difference obtained using the control method of the present disclosure and the conventional vector control method when the motor speed is 2,500 r/min.

FIG. 8A is a simulation effect diagram showing a q-axis current obtained using the control method of the present disclosure when a motor speed is 2,500 r/min;

FIG. 8B is a simulation effect diagram showing a q-axis current obtained using a conventional vector control method when the motor speed is 2,500 r/min; and

FIG. 8C is a simulation effect diagram showing a q-axis current difference obtained using the control method of the present disclosure and the conventional vector control method when the motor speed is 2,500 r/min.

FIG. 9A is a simulation effect diagram showing a torque-to-current ratio obtained using the control method of the present disclosure when a motor speed is 2,500 r/min;

FIG. 9B is a simulation effect diagram showing a torque-to-current ratio obtained using a conventional vector control method when the motor speed is 2,500 r/min; and

FIG. 9C is a simulation effect diagram showing a torque-to-current ratio difference obtained using the control method of the present disclosure and the conventional vector control method when the motor speed is 2,500 r/min.

### DETAILED DESCRIPTION OF THE EMBODIMENTS

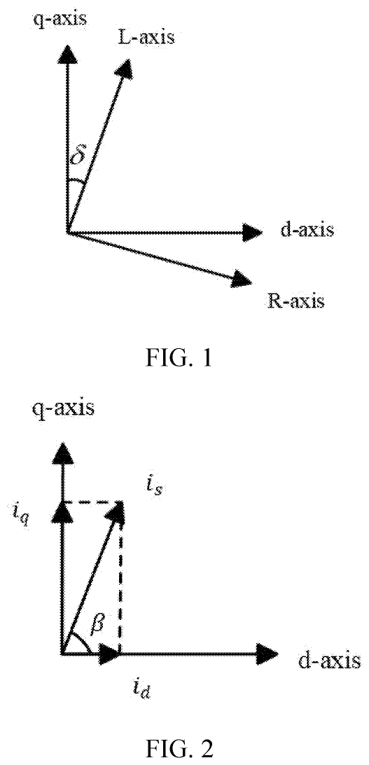

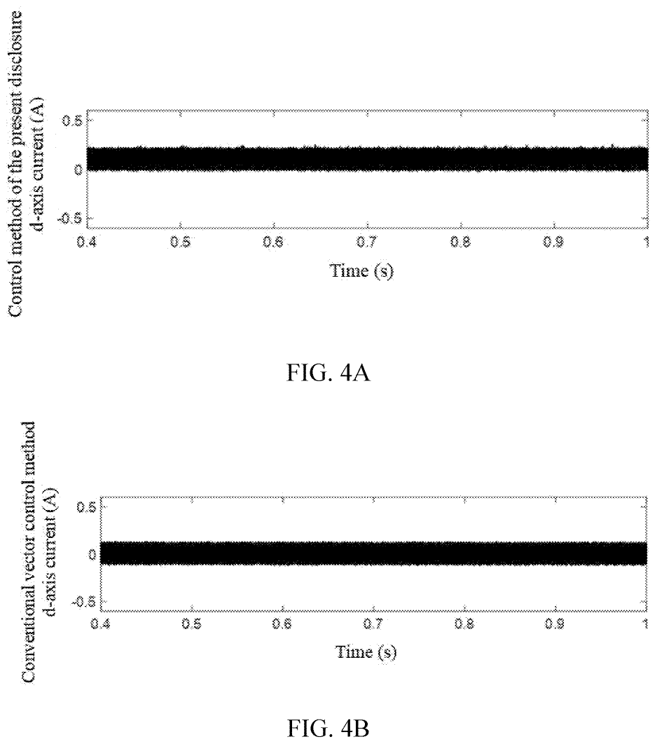

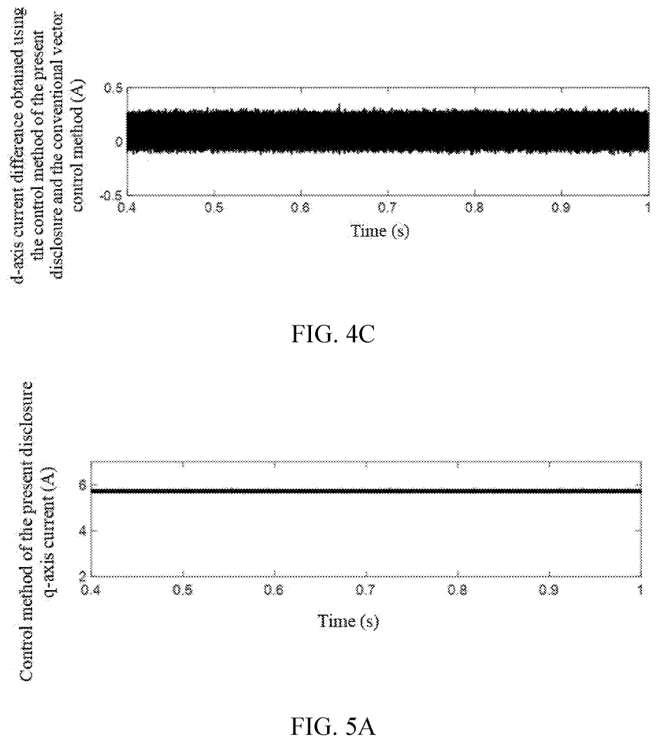

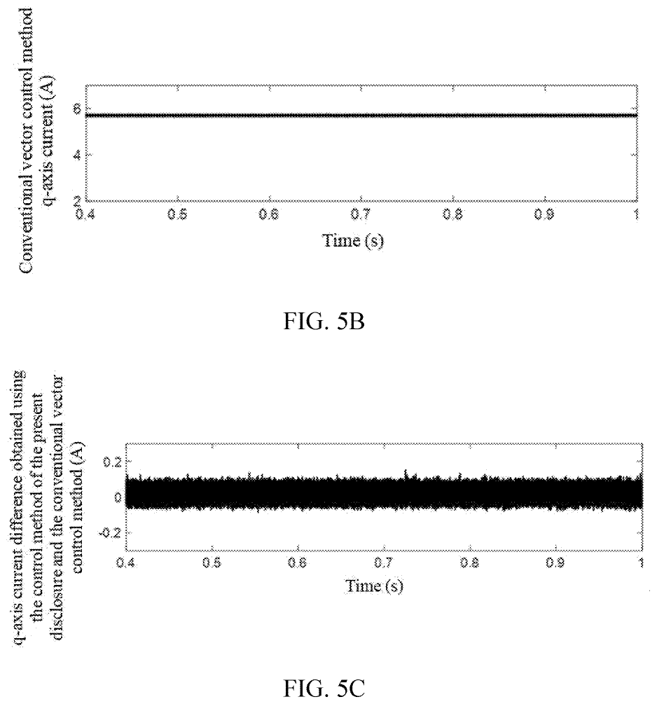

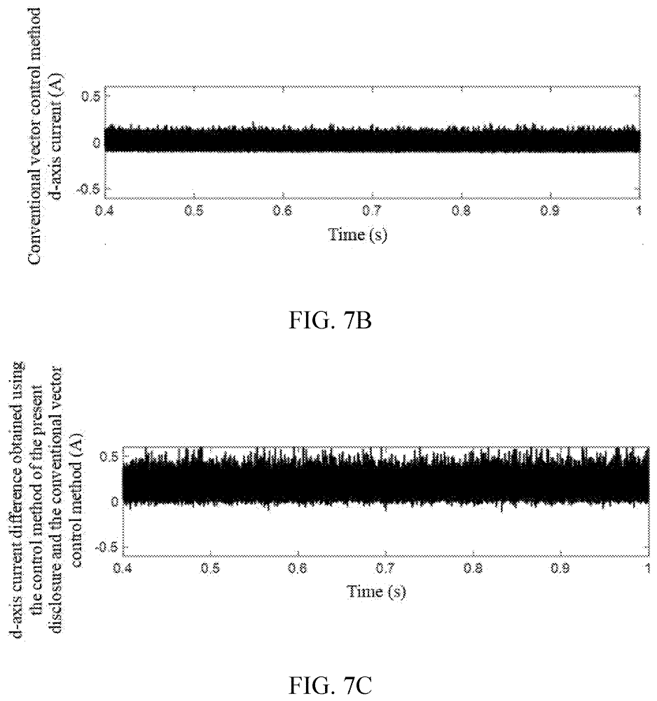

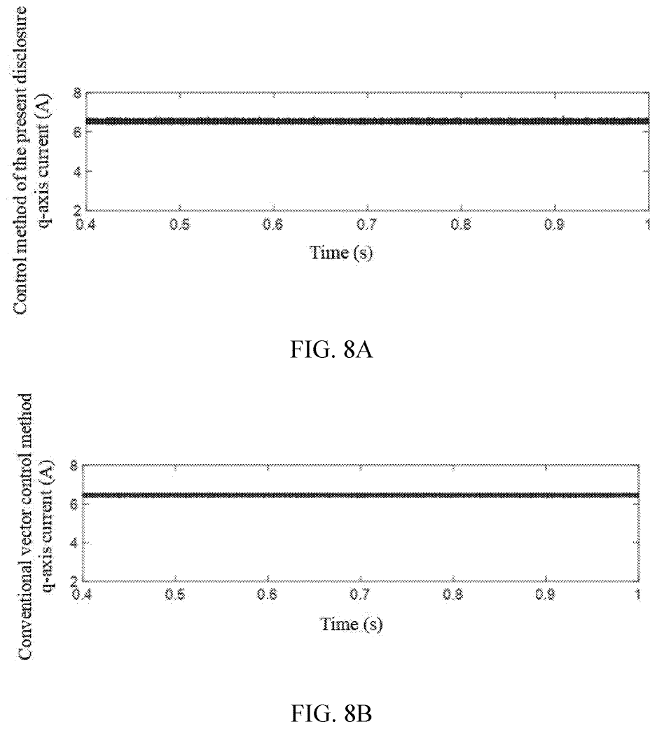

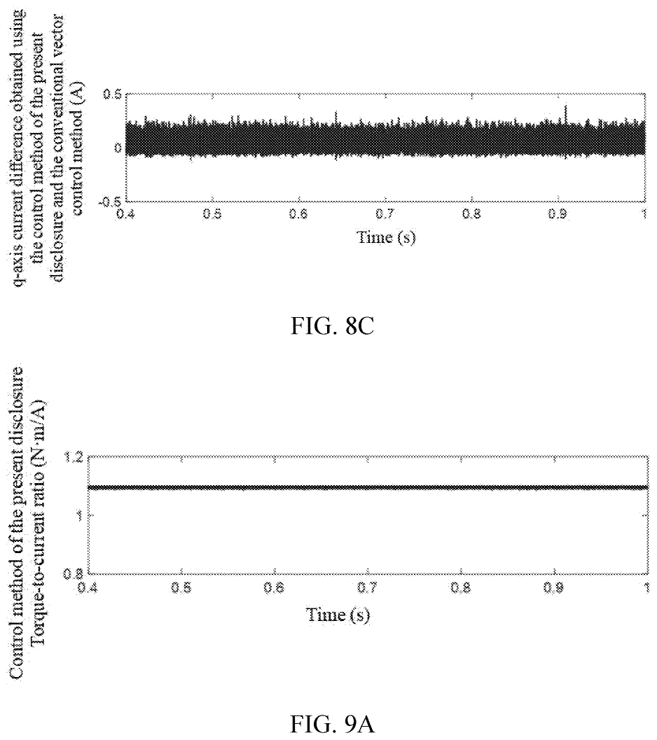

Based on the contents of the present disclosure and in conjunction with FIGS. 1-3 thereof, a specific embodiment of a maximum torque per ampere (MTPA) control method for a surface permanent magnet synchronous motor (SPMSM) based on a vector magnetic circuit has been implemented, and FIGS. 4A-9C show simulation results of the specific implementation.

The present disclosure provides an electromagnetic torque equation based on the vector magnetic circuit and an MTPA control method for an SPMSM. The method includes the following steps:

In step 1, direct-axis (d-axis) and quadrature-axis (q-axis) vector magnetic circuit models of the SPMSM are established, and an arctangent value of a ratio of equivalent magnetic inductive reactance ω [symbol] _{eq} to reluctance [symbol] ₛ is taken as a magnetic impedance angle δ. The magnetic impedance angle is used for characterizing an influence of eddy current and hysteresis effects causing iron loss on an electromagnetic torque.

Two vector magnetic circuit parameters, namely magductance [symbol] and hysteretance C, are introduced into the d-axis and q-axis magnetic circuit models of the SPMSM to construct the d-axis and q-axis vector magnetic circuit models, in which the magductance [symbol] and the hysteretance C are used for characterizing magnitudes of the eddy current and hysteresis effects causing the iron loss. Both the magductance [symbol] and the hysteretance C are capable of causing a magnetic flux to lag behind a magnetomotive force or a current, so a combined effect of the magductance [symbol] and the hysteretance C is equivalently represented by an equivalent magductance parameter [symbol] _{eq}. In the d-axis and q-axis vector magnetic circuit models, an angle by which the magnetic flux lags behind the magnetomotive force or the current is the magnetic impedance angle δ, expressed as:

$$δ = arc tan ( \frac{ω {ℒ}_{e q}}{{ℛ}_{s}} ) = arc tan ( \frac{ω ℒ + \frac{1}{ω C}}{{ℛ}_{s}} ) . \qquad ( 1 )$$

An expression is defined as:

$$k = \frac{{ℒ}_{e q}}{{N}^{2}} = \frac{ℒ + \frac{1}{{ω}^{2} C}}{{N}^{2}} \qquad ( 2 )$$

where k is referred to as an equivalent magductance parameter, obtained through experiments, and in the present disclosure, the equivalent magductance parameter is considered as a fixed parameter without variation. Since reluctance is expressed as

$${ℛ}_{s} = \frac{{N}^{2}}{{L}_{s}} ,$$

the magnetic impedance angle of the SPMSM is expressed as:

$$δ = arc tan ( ω {L}_{s} k ) . \qquad ( 3 )$$

In Equations (1)-(3), [symbol] is the magductance in a direct-quadrature (d-q) coordinate system, C is the hysteretance in the d-q coordinate system, [symbol] _{eq} is the equivalent magductance in the d-q coordinate system, [symbol] ₛ is the reluctance in the d-q coordinate system, Lₛ is inductance in the d-q coordinate system, k is the equivalent magductance parameter, δ is the magnetic impedance angle, ω is rotor electrical angular velocity, and N is the number of turns of armature winding.

In step 2, the equivalent magductance parameter [symbol] _{eq} is introduced into the d-axis and q-axis magnetic circuit equations of the SPMSM, and coordinate transformation is performed to obtain d-axis and q-axis magnetic circuit equations in the d-q coordinate system:

$$\{ \begin{matrix}{ℱ}_{d} = {ℛ}_{s} {Φ}_{d} + {ℒ}_{eq} p {Φ}_{d} - ω {ℒ}_{eq} {Φ}_{q} \\ {ℱ}_{q} = {ℛ}_{s} {Φ}_{q} + {ℒ}_{eq} p {Φ}_{q} + ω {ℒ}_{eq} {Φ}_{d}\end{matrix} . \qquad ( 4 )$$

In Equation (4),

$${ℱ}_{d} = {Ni}_{d} + \frac{{ψ}_{f} {ℛ}_{s}}{N}$$

and [symbol] =Ni_{q} are the d-axis magnetomotive force and the q-axis magnetomotive force in the d-q coordinate system, Φ_{d} and Φ_{q} are the d-axis magnetic flux and the q-axis magnetic flux in the d-q coordinate system, i_{d} and i_{q} are the d-axis current and the q-axis current in the d-q coordinate system,

$${ℛ}_{s} = \frac{{N}^{2}}{{L}_{s}}$$

is the reluctance in the d-q coordinate system, [symbol] _{eq} is the equivalent magductance in the d-q coordinate system, Lₛ is the inductance in the d-q coordinate system, ψ_{f} is the permanent magnet flux linkage, ω is the rotor electrical angular velocity, and p is a differential operator.

When the motor operates in a steady state, the d-axis and q-axis magnetic circuits are considered to be in a steady state, further obtaining:

$$\{ \begin{matrix}{L}_{s} {i}_{d} + {ψ}_{f} = - ω {kL}_{s} {ψ}_{q} + {ψ}_{d} \\ {L}_{s} {i}_{q} = ω {kL}_{s} {ψ}_{d} + {ψ}_{q}\end{matrix} . \qquad ( 5 )$$

Combining Equation (3) and Equation (5), a flux linkage equation of the SPMSM based on the vector magnetic circuit in the d-q coordinate system is obtained:

$$[ \begin{matrix}1 & - tan δ \\ tan δ & 1\end{matrix} ] [ \begin{matrix}{ψ}_{d} \\ {ψ}_{q}\end{matrix} ] = [ \begin{matrix}{L}_{s} & 0 \\ 0 & {L}_{s}\end{matrix} ] [ \begin{matrix}{i}_{d} \\ {i}_{q}\end{matrix} ] + [ \begin{matrix}{ψ}_{f} \\ 0\end{matrix} ] . \qquad ( 6 )$$

Further, multiplying two sides of Equation (6) by cos δ yields:

$${M}_{δ} [ \begin{matrix}{ψ}_{d} \\ {ψ}_{q}\end{matrix} ] = [ \begin{matrix}{L}_{s} cos δ & 0 \\ 0 & {L}_{s} cos δ\end{matrix} ] [ \begin{matrix}{i}_{d} \\ {i}_{q}\end{matrix} ] + [ \begin{matrix}{ψ}_{f} cos δ \\ 0\end{matrix} ] . \qquad ( 7 )$$

In Equation (7),

$${M}_{δ} = [ \begin{matrix}cos δ & - sin δ \\ sin δ & cos δ\end{matrix} ]$$

a coordinate transformation matrix, which rotates the d-q coordinate system in a lagging direction by the magnetic impedance angle δ to obtain an R-L coordinate system, as shown in FIG. 1.

In Equations (5)-(7), ψ_{d} and ψ_{q} are the d-axis flux linkage and the q-axis flux linkage in the d-q coordinate system, i_{d} and i_{q} are the d-axis current and the q-axis current in the d-q coordinate system, Lₛ is the inductance in the d-q coordinate system, ψ_{f} is the permanent magnet flux linkage, and ω is the rotor electrical angular velocity.

After the d-axis and q-axis voltages (flux linkages) are transformed by the coordinate transformation matrix M_{δ}, R-axis and L-axis voltages (flux linkages) are obtained. Further, according to Equation (7), a flux linkage equation of the SPMSM based on the vector magnetic circuit and in the R-L coordinate system is obtained:

$$[ \begin{matrix}{ψ}_{ℛ} \\ {ψ}_{ℒ}\end{matrix} ] = [ \begin{matrix}{L}_{s} cos δ & 0 \\ 0 & {L}_{s} cos δ\end{matrix} ] [ \begin{matrix}{i}_{d} \\ {i}_{q}\end{matrix} ] + [ \begin{matrix}{ψ}_{f} cos δ \\ 0\end{matrix} ] . \qquad ( 8 )$$

A voltage equation of the SPMSM in the R-L coordinate system is:

$$[ \begin{matrix}{u}_{ℛ} \\ {u}_{ℒ}\end{matrix} ] = [ \begin{matrix}{R}_{s} & 0 \\ 0 & {R}_{s}\end{matrix} ] [ \begin{matrix}{i}_{ℛ} \\ {i}_{ℒ}\end{matrix} ] + [ \begin{matrix}p {ψ}_{ℛ} \\ p {ψ}_{ℒ}\end{matrix} ] + [ \begin{matrix}- ω {L}_{ℒ} \\ ω {ψ}_{ℛ}\end{matrix} ] . \qquad ( 9 )$$

Further, according to the relationship

$$[ \begin{matrix}{i}_{ℛ} \\ {i}_{ℒ}\end{matrix} ] = {M}_{δ} [ \begin{matrix}{i}_{d} \\ {i}_{q}\end{matrix} ]$$

and Equation (8), the d-axis and q-axis currents are replaced with the R-axis and L-axis currents, and the R-axis and L-axis flux linkages are substituted, obtaining from Equation (9):

$$[ \begin{matrix}{u}_{ℛ} \\ {u}_{ℒ}\end{matrix} ] = [ \begin{matrix}{R}_{s} cos δ + {pL}_{s} cos δ & - ( {R}_{s} sin + ω {L}_{s} cos δ ) \\ {R}_{s} sin δ + ω {L}_{s} cos δ & {R}_{s} cos δ + {pL}_{s} cos δ\end{matrix} ] [ \begin{matrix}{i}_{d} \\ {i}_{q}\end{matrix} ] + [ \begin{matrix}0 \\ ω {ψ}_{f} cos δ\end{matrix} ] . \qquad ( 10 )$$

Since Rₛ sinδ<<ωLₛ cos δ, Rₛ sin δ in Equation (10) is neglected, and a voltage equation of the SPMSM based on the vector magnetic circuit and in the R-L coordinate system is obtained according to Equation (10):

$$[ \begin{matrix}{u}_{ℛ} \\ {u}_{ℒ}\end{matrix} ] = [ \begin{matrix}{R}_{s} cos δ + {pL}_{s} cos δ & - ω {L}_{s} cos δ \\ ω {L}_{s} cos δ & {R}_{s} cos δ + {pL}_{s} cos δ\end{matrix} ] [ \begin{matrix}{i}_{d} \\ {i}_{q}\end{matrix} ] + [ \begin{matrix}0 \\ ω {ψ}_{f} cos δ\end{matrix} ] . \qquad ( 11 )$$

Multiplying two sides of Equation (8) on the left by the inverse matrix

$${M}_{∞}^{- 1}$$

of the R-L coordinate transformation matrix yields a flux linkage equation of the SPMSM based on the vector magnetic circuit in the d-d coordinate system:

$$[ \begin{matrix}{ψ}_{d} \\ {ψ}_{q}\end{matrix} ] = [ \begin{matrix}{L}_{s} {cos}^{2} δ & {L}_{s} sin δ cos δ \\ - {L}_{s} sin δ cos δ & {L}_{s} {cos}^{2} δ\end{matrix} ] [ \begin{matrix}{i}_{d} \\ {i}_{q}\end{matrix} ] + [ \begin{matrix}{ψ}_{f} {cos}^{2} δ \\ - {ψ}_{f} sin δ cos δ\end{matrix} ] . \qquad ( 12 )$$

In Equations (8)-(12), ψ_{d} and ψ_{q} are the flux linkages in the d-q coordinate system, [symbol] and [symbol] are the R-axis flux linkage and the L-axis flux linkage in the R-L coordinate system [symbol] and [symbol] are the R-axis voltage and the L-axis voltage in the R-L coordinate system, [symbol] and [symbol] are the R-axis current and the L-axis current in the R-L coordinate system, i_{d} and i_{q} are the currents in the d-q coordinate system, Lₛ is the inductance in the d-q coordinate system, Rₛ is the resistance in the d-q coordinate system, ψ_{f} is the permanent magnet flux linkage, δ is the magnetic impedance angle, ω is the rotor electrical angular velocity, and p is a differential operator.

In step 3, the SPMSM electromagnetic torque equation and motion equation are established in the d-q coordinate system based on the vector magnetic circuit:

An SPMSM electromagnetic torque equation without considering eddy current and hysteresis effects in the d-q coordinate system is expressed as:

$${T}_{e} = \frac{3}{2} {p}_{n} ( {ψ}_{d} {i}_{q} - {ψ}_{q} {i}_{d} ) . \qquad ( 13 )$$

The d-axis and q-axis flux linkages based on the vector magnetic circuit, i.e., Equation (12), are substituted into Equation (13) to obtain an SPMSM electromagnetic torque equation, which is based on the vector magnetic circuit and considers eddy current and hysteresis effects in the d-q coordinate system:

$${T}_{δ} = \frac{3}{2} {p}_{n} [ \frac{1}{2} {L}_{s} sin 2 δ * ( {i}_{d}^{2} + {i}_{q}^{2} ) + {ψ}_{f} {cos}^{2} δ * {i}_{q} + \frac{1}{2} {ψ}_{f} sin 2 δ * {i}_{d} ] . \qquad ( 14 )$$

According to the present disclosure, the SPMSM electromagnetic torque equation based on the vector magnetic circuit includes d-axis and q-axis current components. Therefore, when an MTPA control method is adopted, an optimal combination of a d-axis current and a q-axis current under a current operating state needs to be found, expressed as follows:

$$\{ \begin{matrix}{T}_{δ} = \frac{3}{2} {p}_{n} [ \frac{1}{2} {L}_{s} sin 2 δ * ( {i}_{d}^{2} + {i}_{q}^{2} ) + {ψ}_{f} {cos}^{2} δ * {i}_{q} + \frac{1}{2} {ψ}_{f} sin 2 δ * {i}_{d} ] \\ {i}_{s} = min \sqrt{{i}_{d}^{2} + {i}_{q}^{2}}\end{matrix} . \qquad ( 15 )$$

As shown in FIG. 2, a relationship between a stator current vector and a d-axis current and a q-axis current is expressed as:

$$\{ \begin{matrix}{i}_{d} = {i}_{s} cos β \\ {i}_{q} = {i}_{s} sin β ( 16 )\end{matrix} . \qquad ( 16 )$$

Equation (16) is substituted into Equation (15) to obtain a relationship between the electromagnetic torque and a stator current vector angle:

$${T}_{δ} = \frac{3}{2} {p}_{n} [ \frac{1}{2} {L}_{s} {i}_{s}^{2} sin 2 δ + {ψ}_{f} {cos}^{2} δ ( {i}_{s} sin β ) + \frac{1}{2} {ψ}_{f} sin 2 δ ( {i}_{s} cos β ) ] . \qquad ( 17 )$$

A phase-shift process is performed on the stator current vector is in Equation (17) to obtain an expression of an electromagnetic torque per unit current:

$$F ( β ) = \frac{{T}_{δ}}{{i}_{s}} = \frac{3}{4} {p}_{n} {L}_{s} {i}_{s} sin 2 δ + \frac{3}{2} {p}_{n} {ψ}_{f} sin {βcos}^{2} δ + \frac{3}{4} {p}_{n} {ψ}_{f} sin 2 δcos β . \qquad ( 18 )$$

When a derivative of the electromagnetic torque per unit current with respect to the stator current vector angle is equal to zero, the electromagnetic torque per unit current achieves a maximum value, and a motor operating point corresponding to the stator current vector angle is an MTPA control point, specifically expressed as:

$$\frac{\partial F ( β )}{\partial β} = \frac{3}{2} {p}_{n} {ψ}_{f} cos {βcos}^{2} δ - \frac{3}{4} {p}_{n} {ψ}_{f} sin 2 δ * sin β = 0. \qquad ( 19 )$$

Further, the following is obtained:

$$β = arc tan ( \frac{1}{tan δ} ) . \qquad ( 20 )$$

Further, an SPMSM motion equation is obtained:

$$J \frac{d {ω}_{m}}{dt} = {T}_{δ} - {T}_{L} - B {ω}_{m} . \qquad ( 21 )$$

In Equations (13)-(21), ψ_{d} and ψ_{q} are flux linkages in the d-q coordinate system, Lₛ is inductance in the d-q coordinate system, i_{d} and i_{q} are currents in the d-q coordinate system, iₛ is a stator current vector in the d-q coordinate system, β is an angle between iₛ and a d-axis, ψ_{f} is a permanent magnet flux linkage, pₙ is the number of pole pairs of the motor, δ is a magnetic impedance angle, ωₘ is rotor mechanical angular velocity, J is a moment of inertia, Tₑ is an SPMSM electromagnetic torque without considering eddy current and hysteresis effects in the d-q coordinate system, T_{δ} is an SPMSM electromagnetic torque, which is based on the vector magnetic circuit and considers eddy current and hysteresis effects in the d-q coordinate system, T_{L} is a load torque, and B is a damping coefficient of the motor.

In step 4, an MTPA control method for an SPMSM based on a vector magnetic circuit is established.

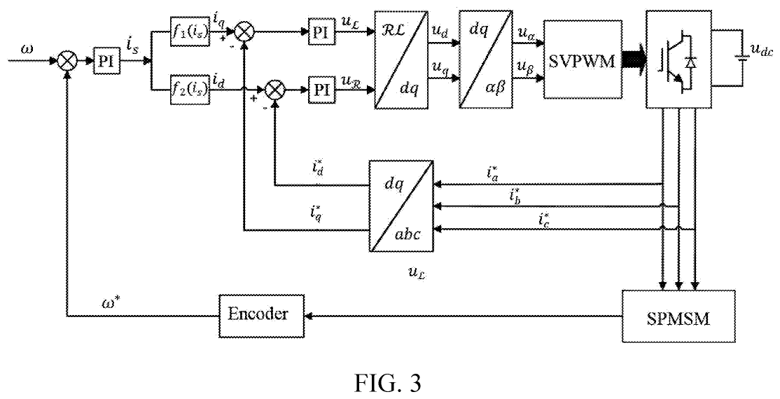

As shown in FIG. 3, three-phase currents of the SPMSM are sampled to obtain sampled values

$${i}_{a}^{*} , {i}_{b}^{*} , and {i}_{c}^{*} ,$$

and the sampled values

$${i}_{a}^{*} , {i}_{b}^{*} , and {i}_{c}^{*}$$

are transformed through coordinate transformation to obtain current sampled values

$${i}_{d}^{*} and {i}_{q}^{*}$$

in a d-q coordinate system.

An error between the rotor electrical angular velocity ω and the rotor electrical angular velocity set value ω* is processed by a proportional-integral (PI) controller to obtain a stator current vector iₛ, and a d-axis current set value i_{d} and a q-axis current set value i_{q} are obtained through a relationship between the stator current vector and a d-axis current and a q-axis current, specifically expressed as:

$${i}_{q} = {f}_{1} ( {i}_{s} ) = {i}_{s} sin β ,$$

$${i}_{d} = {f}_{2} ( {i}_{s} ) = {i}_{s} cos β .$$

Errors between

$${i}_{d}^{*} and {i}_{q}^{*}$$

and the set values i_{d} and i_{q} are input into two PI controllers to obtain voltage set [symbol] and [symbol] in an R-L coordinate system. The voltage set values [symbol] and [symbol] are subjected to an inverse transformation using a coordinate transformation matrix M_{δ} to obtain voltage set values u_{d} and u_{q} in the d-q coordinate system. The voltage set values u_{d} and u_{q} in the d-q coordinate system are transformed through an inverse Park transformation to obtain voltage set values u_{α} and up in an a-b coordinate system. A voltage space vector is synthesized using u_{α} and u_{β}, and is input into a voltage space vector pulse width modulation (SVPWM) module for modulation. State encoding values of three half-bridges at that moment are output to control metal-oxide-semiconductor (MOS) transistor switches of a three-phase inverter for controlling the motor.

A vector control simulation is performed on the SPMSM. The motor speed is first adjusted to 1,500 r/min with a load of 5 N·m, and the motor speed is adjusted to 2,500 r/min with the load still at 5 N·m. Changes in d-axis and q-axis currents of the motor, as well as a torque-to-current ratio, are observed. An effect of the motor model and control method adopted in the present disclosure is compared with that of a conventional motor model using an i_{d}=0 control method. Influences of iron loss on motor control performance at different speeds are compared to verify the feasibility of the electromagnetic torque equation based on the vector magnetic circuit and the MTPA control method for the SPMSM provided in the present disclosure. Parameters of the SPMSM used in the simulation are shown in Table 1:

TABLE 1
Parameters of the SPMSM in the simulation

| Parameter | Value | | Parameter | Value | |
|---|---|---|---|---|---|
| Rated power Pₙ | 2 | kW | Rated line voltage Uₙ | 220 | V |
| Rated speed Nₙ | 2,500 | r/min | Number of pole pairs p | 4 | |
| Moment of inertia J | 0.0015 | kg · m² | Direct current (DC) bus | 311 | V |
| | | | voltage U_{dc} | | |
| Stator resistance Rₛ | 0.505 | Ω | Permanent magnet flux | 0.1326 | Wb |
| | | | linkage ψ_{f} | | |
| d-axis inductance L_{d} | 1.47 | mH | q-axis inductance L_{q} | 1.47 | mH |

| | | | | |
|---|---|---|---|---|
| Equivalent magductance | 0.005/Ω | Rated torque Tₙ | 7.7 | N · m |

coefficient k

As shown in FIGS. 4A-5C and FIGS. 7A-8C, both the d-axis current and the q-axis current in the control method provided in the present disclosure are higher than those in conventional vector control, indicating that eddy current and hysteresis effects have an obstructing effect on the currents under actual motor operating conditions, which demonstrates the correctness of the motor model established and the electromagnetic torque equation provided in the present disclosure.

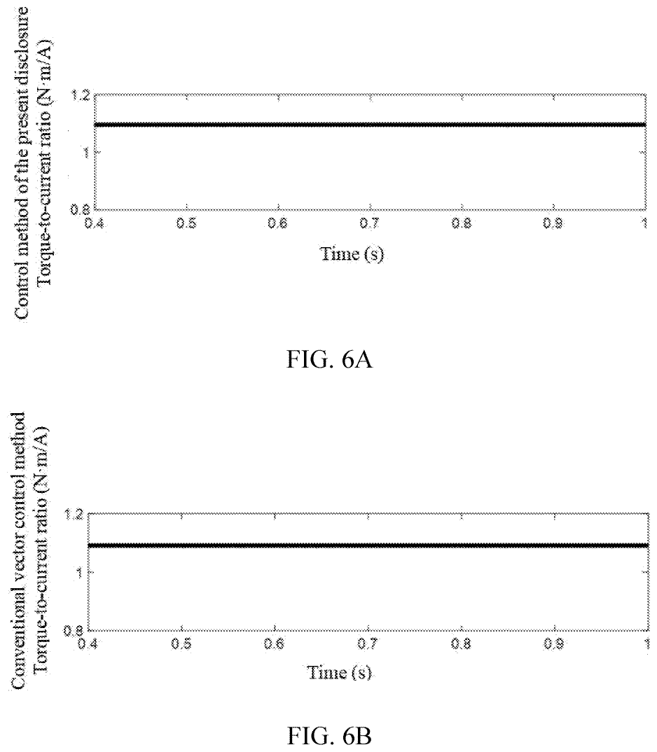

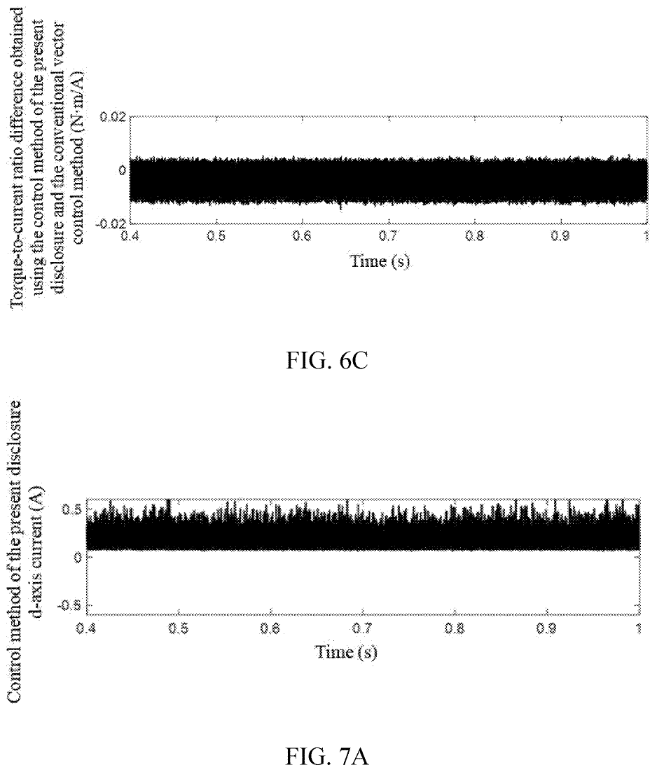

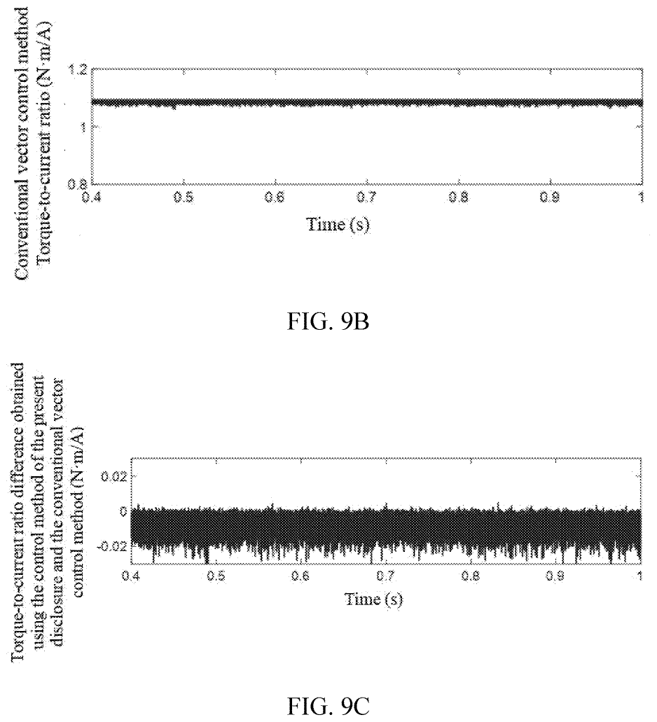

As shown in FIGS. 6A-6C and FIGS. 9A-9C, the torque-to-current ratio of the motor at a speed of 2,500 r/min is smaller than that at 1,500 r/min, indicating that, under the same load torque, a higher speed leads to a greater obstructing effect of eddy current and hysteresis effects on the current, and a greater influence on motor performance, which is indeed of significant importance for precise control of output torque under actual operating conditions.

1. A calculation method for motor electromagnetic torque based on a vector magnetic circuit, comprising: introducing two vector magnetic circuit parameters, namely magductance [symbol] and hysteretance C, into direct-axis (d-axis) and quadrature-axis (q-axis) vector magnetic circuit models of a surface permanent magnet synchronous motor (SPMSM), wherein the magductance L and the hysteretance C are capable of causing a magnetic flux to lag behind a magnetomotive force or a current, and an angle by which the magnetic flux lags behind the magnetomotive force or the current is a magnetic impedance angle δ; and an SPMSM electromagnetic torque equation, which is based on the vector magnetic circuit and considers eddy current and hysteresis effects in a direct-quadrature (d-q) coordinate system, is expressed as follows:
$${T}_{δ} = \frac{3}{2} {p}_{n} [ \frac{1}{2} {L}_{s} sin 2 δ * ( {i}_{d}^{2} + {i}_{q}^{2} ) + {ψ}_{f} {cos}^{2} δ * {i}_{q} + \frac{1}{2} {ψ}_{f} sin 2 δ * {i}_{d} ] \qquad ( 1 )$$
where i_{d} and i_{q} are a d-axis current and a q-axis current in the d-q coordinate system, Lₛ is inductance in the d-q coordinate system, ψ_{f} is a permanent magnet flux linkage, pₙ is the number of pole pairs of the motor, δ is a magnetic impedance angle, and T_{δ} is an SPMSM electromagnetic torque, which is based on the vector magnetic circuit and considers the eddy current and hysteresis effects in the d-q coordinate system.

2. A calculation method for motor maximum torque per ampere (MTPA) based on a vector magnetic circuit, based on the calculation method for motor electromagnetic torque based on a vector magnetic circuit according to claim 1, comprising: calculating the MTPA as follows:
$$\{ \begin{matrix}{T}_{δ} = \frac{3}{2} {p}_{n} [ \frac{1}{2} {L}_{s} sin 2 δ * ( {i}_{d}^{2} + {i}_{q}^{2} ) + {ψ}_{f} {cos}^{2} δ * {i}_{q} + \frac{1}{2} {ψ}_{f} sin 2 δ * {i}_{d} ] \\ {i}_{s} = min \sqrt{{i}_{d}^{2} + {i}_{q}^{2}}\end{matrix} \qquad ( 2 )$$
wherein a relationship between a stator current vector and the d-axis current and the q-axis current is expressed as:
$$\{ \begin{matrix}{i}_{d} = {i}_{s} cos β \\ {i}_{q} = {i}_{s} sin β\end{matrix} \qquad ( 3 )$$
where i_{d} and i_{q} are the d-axis current and the q-axis current in the d-q coordinate system, iₛ is a stator current vector in the d-q coordinate system, β is a stator current vector angle, which is an angle between the stator current vector iₛ and the d-axis, ψ_{f} is the permanent magnet flux linkage, pₙ is the number of pole pairs of the motor, and δ is the magnetic impedance angle.

3. The calculation method for motor MTPA based on a vector magnetic circuit according to claim 2, wherein Equation (3) is substituted into the electromagnetic torque equation in Equation (2), obtaining a relationship between the electromagnetic torque T_{δ} and the stator current vector angle β, as follows:
$${T}_{δ} = \frac{3}{2} {p}_{n} [ \frac{1}{2} {L}_{s} {i}_{s}^{2} sin 2 δ + {ψ}_{f} {cos}^{2} δ ( {i}_{s} sin β ) + \frac{1}{2} {ψ}_{f} sin 2 δ ( {i}_{s} cos β ) ] \qquad ( 5 )$$
a phase-shift process is performed on the stator current vector iₛ, further obtaining an expression of an electromagnetic torque per unit current F(β), as follows:
$$F ( β ) = \frac{{T}_{δ}}{{i}_{s}} = \frac{3}{4} {p}_{n} {L}_{s} {i}_{s} sin 2 δ + \frac{3}{2} {p}_{n} {ψ}_{f} sin {βcos}^{2} δ + \frac{3}{4} {p}_{n} {ψ}_{f} sin 2 δcosβ \qquad ( 6 )$$
a relationship to be satisfied for maximizing the electromagnetic torque per unit current F(β) is:
$$\frac{\partial F ( β )}{\partial β} = \frac{3}{2} {p}_{n} {ψ}_{f} cos {βcos}^{2} δ - \frac{3}{4} {p}_{n} {ψ}_{f} sin 2 δsinβ = 0 \qquad ( 7 )$$
further obtaining:
$$β = arc tan ( \frac{1}{tan δ} ) . \qquad ( 8 )$$

4. The calculation method for motor MTPA based on a vector magnetic circuit according to claim 2, wherein the magnetic impedance angle S is expressed as:
$$δ = arc tan ( \frac{{ωℒ}_{e q}}{{ℛ}_{s}} ) = arc tan ( \frac{ωℒ + \frac{1}{ω C}}{{ℛ}_{s}} ) \qquad ( 1 )$$
an expression is defined as:
$$k = \frac{{ℒ}_{e q}}{{N}^{2}} = \frac{ℒ + \frac{1}{{ω}^{2} C}}{{N}^{2}} \qquad ( 2 )$$
where k is referred to as an equivalent magductance parameter; and
since reluctance is expressed as
$${ℛ}_{s} = \frac{{N}^{2}}{{L}_{s}} ,$$
the magnetic impedance angle S of the SPMSM is expressed as:
$$δ = arc tan ( ω {L}_{s} k ) \qquad ( 3 )$$
where [symbol] is magductance in the d-q coordinate system, C is hysteretance in the d-q coordinate system, [symbol] _{eq} is equivalent magductance in the d-q coordinate system, [symbol] ₛ is reluctance in the d-q coordinate system, Lₛ is inductance in the d-q coordinate system, k is an equivalent magductance coefficient, δ is the magnetic impedance angle, ω is electrical angular velocity of a rotor, and N is the number of turns of armature winding.

5. The calculation method for motor MTPA based on a vector magnetic circuit according to claim 2, wherein a voltage equation of the SPMSM based on the vector magnetic circuit is expressed as:
$$[ \begin{matrix}{u}_{ℛ} \\ {u}_{ℒ}\end{matrix} ] = [ \begin{matrix}{R}_{s} cos δ + {pL}_{s} cos δ & - ω {L}_{s} cos δ \\ ω {L}_{s} cos δ & {R}_{s} cos δ + {pL}_{s} cos δ\end{matrix} ] [ \begin{matrix}{i}_{d} \\ {i}_{q}\end{matrix} ] + [ \begin{matrix}0 \\ {ωψ}_{f} cos δ\end{matrix} ] \qquad ( 9 )$$
where [symbol] and [symbol] are voltages in an R-L coordinate system, i_{d} and i_{q} are the currents in the d-q coordinate system, Lₛ is inductance in the d-q coordinate system, Rₛ is resistance in the d-q coordinate system, ψ_{f} is the permanent magnet flux linkage, δ is the magnetic impedance angle, ω is electrical angular velocity of a rotor, and p is a differential operator.

6. The calculation method for motor MTPA based on a vector magnetic circuit according to claim 5, wherein a relationship between the voltages in the R-L coordinate system and voltages in the d-q coordinate system is expressed as:
$$[ \begin{matrix}{u}_{ℛ} \\ {u}_{ℒ}\end{matrix} ] = {M}_{δ} [ \begin{matrix}{u}_{d} \\ {u}_{q}\end{matrix} ] \qquad ( 10 )$$
where M_{δ} is a coordinate transformation matrix, expressed as:
$${M}_{δ} = [ \begin{matrix}cos δ & - sin δ \\ sin δ & cos δ\end{matrix} ] . \qquad ( 11 )$$

7. A motor control method based on a vector magnetic circuit, comprising: introducing two vector magnetic circuit parameters, namely magductance [symbol] and hysteretance C, into direct-axis (d-axis) and quadrature-axis (q-axis) vector magnetic circuit models of a surface permanent magnet synchronous motor (SPMSM), wherein the magductance [symbol] and the hysteretance C are capable of causing a magnetic flux to lag behind a magnetomotive force or a current, and an angle by which the magnetic flux lags behind the magnetomotive force or the current is a magnetic impedance angle δ; and
further comprising the steps of:
sampling three-phase currents of the SPMSM to obtain sampled values
$${i}_{a}^{*} , {i}_{b}^{*} , and {i}_{c}^{*} ,$$
and i*, and performing a coordinate transformation on
$${i}_{a}^{*} , {i}_{b}^{*} , and {i}_{c}^{*}$$
to obtain current sampled values
$${i}_{d}^{*} and {i}_{d}^{*}$$
in a direct-quadrature (d-q) coordinate system;
processing an error between rotor electrical angular velocity ω* and rotor electrical angular velocity set value ω by a proportional-integral (PI) controller to obtain a stator current vector iₛ, and obtaining a d-axis current set value i_{d} and a q-axis current set value i_{q} through a relationship between the stator current vector and q-axis and d-axis currents, specifically:
$${i}_{q} = {i}_{s} sin β ,$$
$${i}_{d} = {i}_{s} cos β , and$$
$$β = arc tan ( \frac{1}{tan δ} ) ,$$
where β represents a stator current vector angle, and δ represents the magnetic impedance angle;
inputting errors between the current sampled values
$${i}_{d}^{*} and {i}_{q}^{*}$$
in the d-q coordinate system and the set values i_{d} and i_{q} into two PI controllers to obtain voltage set values [symbol] and [symbol] an R-L coordinate system, wherein
the R-L coordinate system is obtained by rotating the d-q coordinate system in a lagging direction by the magnetic impedance angle δ, and
$${M}_{δ} = [ \begin{matrix}cos δ & - sin δ \\ sin δ & cos δ\end{matrix} ]$$
is a coordinate transformation matrix; and
performing an inverse transformation on [symbol] and [symbol] using the coordinate transformation matrix M_{δ} to obtain voltage set values u_{d} and u_{q} in the d-q coordinate system; performing an inverse Park transformation to transform the voltage set values u_{d} and u_{q} in the d-q coordinate system into voltage set values u_{α} and u_{β} in an a-b coordinate system; synthesizing a voltage space vector using u_{α} and u_{β}; inputting the voltage space vector into a voltage space vector pulse width modulation (SVPWM) module for modulation; and outputting state encoding values of three half-bridges to control metal-oxide-semiconductor (MOS) transistor switches of a three-phase inverter for controlling the motor.

8. The motor control method based on a vector magnetic circuit according to claim 7, wherein an operating point of the motor corresponding to the stator current vector angle β is a maximum torque per ampere (MTPA) control point.
